(19) United States
(12) Patent Application Publication
(10) Pub. No.: US 2026/0084780 A1
(43) Pub. Date: Mar. 26, 2026

(54) Method for Controlling a Drive Unit of a Vehicle

(71) Applicant: Robert Bosch GmbH, Stuttgart (DE)

(72) Inventors: Tim Dackermann, Tuebingen (DE); Daniel Baumgaertner, Neustetten (DE)

(21) Appl. No.: 18/880,558

(22) PCT Filed: Jul. 6, 2023
(86) PCT No.: PCT/EP2023/068664

§ 371 Date: Nov. 26, 2025

(30) Foreign Application Priority Data
Jul. 6, 2022 (DE) 10 2022 206 893.9
Jul. 5, 2023 (DE) 10 2023 206 365.4

(51) Int. Cl. B62M 6/50; B62J 45/41

(52) U.S. Cl. CPC B62M 6/50; B62J 45/41

(57) ABSTRACT

A method for controlling a drive unit of a vehicle, in particular a single-track vehicle such as an eBike, that includes a drive unit and a sensor unit with at least one sensor element, is disclosed. The method includes (i) sensing a sensor signal by the at least one sensor element, (ii) determining the staircase based on the detected sensor signal, in particular by the sensor unit, and (iii) controlling the drive unit based on the determined staircase.

The invention relates to a method for controlling a drive unit of a vehicle, in particular a single-track vehicle such as an eBike.

The invention also relates to a vehicle, in particular a single-track vehicle such as an eBike.

Although the present invention is generally applicable to any vehicle, the present invention is described in relation to single-track vehicles in the form of eBikes.

### PRIOR ART

To climb stairs, eBike riders must either carry or push their eBikes up the stairs. In particular, eBikes are very heavy due to the battery and the drive unit, so that carrying or pushing the eBike requires considerable effort.

E-bikes can have a pushing assistance function that can be used to make it easier to push an e-bike up stairs. A bicycle with an auxiliary drive has been made public in DE 198 02 937 A1. This allows a user to manually activate a pushing assistance in front of a staircase, making it easier to push the bicycle up the stairs.

### DISCLOSURE OF THE INVENTION

In one embodiment, the present invention provides a method for controlling a drive unit of a vehicle, in particular a single-track vehicle such as an eBike, comprising a drive unit and a sensor unit with at least one sensor element, comprising the steps:
sensing a sensor signal by the at least one sensor element,
determining the staircase based on the detected sensor signal, in particular by the sensor unit, and
Controlling the drive unit based on the determined staircase.

The vehicle, in particular a single-track vehicle such as an eBike, can also be a multi-track vehicle. For example, the vehicle is equipped with three or four wheels. In particular, the vehicle is a pedelec, S-pedelec or an electric bicycle.

In one embodiment, the present invention provides a method for determining route information, wherein at least one route section has information that has been determined by a method according to claim 16.

In one embodiment, the present invention provides a drive unit for a vehicle, in particular a single-track vehicle such as an eBike, wherein the drive unit comprises a sensor unit with at least one sensor element and is designed to carry out the method according to the invention.

In one embodiment, the present invention is a vehicle, in particular a single-track vehicle such as an eBike with a previously mentioned drive unit.

The sensor unit may include a gyroscope, an inertial sensor and/or a camera. In particular, the sensor unit can be a smartphone. The sensor unit can be used to detect the geometry of the staircase. The sensor unit can be part of the drive unit. Alternatively or additionally, the sensor unit can have its own housing. The sensor unit can be located inside the drive unit or outside the drive unit. To carry out the method, the drive unit in particular has a control unit. The control unit is designed to control the drive unit. The control unit includes, in particular, the sensor unit. The control unit includes, in particular, an execution device that controls the drive unit based on the detected stairs.

One of the advantages this brings is that a staircase is automatically recognized, which increases user-friendliness. Another advantage is that one or more follow-up actions or activities can be carried out for the user. Another advantage is that the control of the drive unit can be carried out as a pre-settable, in particular vehicle-based follow-up measure depending on the stairs determined, for example, the activation of a pushing assistance arranged in the vehicle or the adjustment of a degree of assistance.

In particular, a staircase is an obstacle that comprises at least two steps and/or step-like elevations. In particular, a step is a difference in height from a first level to a second level, wherein the second level may be higher or lower than the first level. A staircase exhibits a regularity, in particular a regularity of the steps, which are cyclically repeated.

The sensor signal for detecting the stairs can be measured in particular by the sensor element; for example, the sensor signal can correspond to a physical quantity.

In particular, a pushing assistance is defined as a vehicle drive unit that is in contact with the vehicle while it is being pushed by a user.

The term “vehicle-based” in relation to a follow-up action is to be understood in the broadest sense and refers, preferably in the description, to any action, execution, procedure, process and/or instruction that provides a change in the state of the vehicle, in particular the speed, acceleration, direction or similar.

Further features, advantages and other embodiments of the invention are described in the following or are thereby disclosed.

According to a favorable further development of the invention, the staircase is determined on the basis of an in particular undulating and/or cyclic acceleration curve in the direction of a longitudinal axis of the vehicle. In particular, the vehicle's longitudinal axis is defined as an axis approximately parallel to an axis through the centers of the front and rear wheels of the vehicle. If the vehicle is a tricycle, the longitudinal axis of the vehicle is parallel to the direction of travel with the handlebars held straight. The acceleration of the vehicle can be measured, for example, by at least one inertial sensor. When a vehicle is pushed up the stairs, the vehicle is periodically moved up one step and then along the step to the next step. This results in a regular acceleration curve in the longitudinal axis of the vehicle, which can be used to detect stairs. One advantage of this is that a staircase can be reliably detected.

According to a favorable further development of the invention, the staircase is determined on the basis of an in particular undulating and/or cyclic acceleration curve in the direction of a vehicle vertical axis. An acceleration curve is defined as the change in acceleration in the direction of an axis over time. The vehicle is lifted in a regular manner by the steps, so that the values of the acceleration in the direction of the vehicle's vertical axis—in particular perpendicular to the ground—also fluctuate regularly. This can be used to detect the stairs. The advantage of this is that the stairs can be reliably recognized.

According to a favorable further development of the invention, the staircase is determined on the basis of a particularly undulating and/or cyclic rotation rate curve in the direction of a nodding axis of the vehicle. While the vehicle is being pushed up a step, the pitch angle changes abruptly. It then remains constant until the vehicle reaches the next step. This results in a wave-like pitch angle, which can be an indicator that the vehicle is being pushed up stairs. The pitch angle, for example, can be measured using a gyroscope. This ensures that a staircase can be reliably detected.

According to a favorable further development of the invention, the staircase is determined on the basis of a particularly undulating and/or cyclic rotational speed curve and/or a curve of one or more electrical drive characteristics in the drive unit of the vehicle. The electrical drive parameters can be, in particular, a current strength, a voltage and/or an electrical power. Due to the cyclic curve of the staircase, the torque required to push up the vehicle regularly increases and decreases, so that an electrical drive characteristic in the drive unit or a rotational speed of the drive unit also has a cyclic curve. This means that a staircase can also be reliably detected.

According to a favorable further development of the invention, the staircase is determined by means of an optical and/or acoustic recognition device, in particular a camera. For example, a user's smartphone can be attached to the vehicle, which can recognize a staircase in front of the vehicle using a camera and an image recognition program. One advantage of this is that a staircase can be recognized before the vehicle has reached the staircase. Furthermore, the stairs can be detected, for example, by a radar signal, an ultrasonic signal or the like.

According to a favorable further development of the invention, the staircase is determined on the basis of position data of the vehicle and/or position data of the staircase. For example, the current position of the vehicle can be determined using a GPS signal. By comparing the current image with a map and the marked stairs, the system can determine whether the vehicle is in front of and/or on a staircase. This is an easy way to determine a staircase.

According to a further advantageous development of the invention, the control of the drive unit includes an adjustment of an assistance level, in particular a torque assistance level of the drive unit. The advantage of this is that once the staircase has been determined, the state of the drive can be adapted to the staircase. In particular, a suitable change of position of the vehicle can be suggested to a user. A suitable change of position can be, for example, a navigation instruction.

According to a favorable further development of the invention, the vehicle comprises a pushing assistance, and wherein the control of the drive unit comprises an, in particular automatic, activation and/or adjustment of the pushing assistance based on the determined staircase. One advantage of this is that a user can push the vehicle up the stairs more comfortably and with less effort, since the pushing assistance can be adjusted based on the stairs, in particular the staircase characteristics.

According to a favorable further development of the invention, the control of the drive unit, an adjustment or modification, in particular an adjustment or modification of the pushing assistance, in particular a reduction, of a torque of the drive unit, in particular an adjustment of the pushing assistance, a modification, in particular a reduction, of a torque of the drive unit of the vehicle. It is conceivable that, alternatively or additionally, a speed of the vehicle is reduced. If the vehicle is traveling at high speed, there is a risk that it will move suddenly when it hits the stairs or even slip out of the user's hands. Reducing the speed gives the user more control over the vehicle, which improves the user experience. In particular, cyclic reduction of the drive unit torque is beneficial.

According to a favorable further development of the invention, the length, height, slope, beginning, end, step height and/or regularity of the step height of the staircase is determined. By defining the geometry and shape of the stairs, the pushing assistance in particular can be better adapted to the stairs that currently need to be climbed. The length of the staircase is in particular the length of the distance between the first and the last step, the height is in particular the difference in height meters between the first and the last step, the incline is in particular the angle between an axis along the staircase and a horizontal, the beginning and the end of the staircase are in particular the transition from a surface to the first step or from a last step to the surface, the step height is in particular the difference in height in meters between an individual step and a previous and/or subsequent step and the regularity of the step height is in particular the relative difference in step height of the individual steps, wherein, for example, the standard deviation of the step height and/or the difference in step height of successive steps can be used as a measure of the regularity. The geometry and shape of the stairs can be used in particular to control the drive unit while the vehicle is driving up or down the stairs or while the vehicle is being pushed up the stairs.

According to a favorable further development of the invention, the control of the drive unit is additionally carried out taking into account a position and/or rotation of the vehicle in relation to the stairs, at least one acceleration of the vehicle, a step height and/or a regularity of the step height. In particular, this advantageous further training involves changing the torque of the drive unit. The advantage of this is that it is easier and safer for a user to push the vehicle up the stairs. For example, the torque of the drive unit and/or the speed can be reduced when the vehicle is pushed up a step and/or increased when the vehicle has pushed up the step. Furthermore, it is conceivable that the torque and/or speed at the beginning and/or in the middle of the stairs is reduced and/or increased when a front wheel of the vehicle has passed the stairs. It is also possible that the torque and/or speed is reduced if the steps are relatively high and/or irregular in shape. In other words, changing the torque in particular can be used to increase the torque at the right time, especially when climbing a subsequent step.

According to a favorable further development of the invention, the control of the drive unit additionally includes the following further step: Determining an alternative route to bypass the stairs. This means that a user can automatically be suggested an alternative route that bypasses the stairs, so that no effort is required to climb them. The determination of an alternative route, for example, can be based on position data and/or map data.

According to a favorable further development of the invention, the control of the drive unit is additionally based on a predicted impact event on a step. A trigger event is the first contact of the vehicle with a new step, in particular physical contact. If the staircase is regular, it is possible to estimate when the next step will be reached. To cushion the impact on the vehicle, the speed of the vehicle can be reduced before the next step, for example.

According to a favorable further development of the invention, the control of the drive unit is additionally based on a setting of the user. User preferences can, for example, be set by the user and/or learned automatically using machine learning. Depending on these settings, the pushing assistance, for example, can be adjusted to adapt the pushing of the vehicle to the user's needs. For example, the pushing assistance can be set to a desired number of steps climbed per minute. This makes it easier for the user to push the vehicle up the stairs. It is conceivable that a user can set whether they prefer to push the vehicle up stairs or would rather avoid stairs.

According to a favorable further development of the invention, the control of the drive unit additionally comprises storing information about the determined staircase in a local and/or global database. By saving information about the staircase, such as length, height, incline, step height, etc., the pushing assistance can be better adapted to the geometry of the staircase the next time you have to climb it. The information can be stored locally, i.e. only accessible by the vehicle itself, and/or globally, i.e. accessible by various vehicles.

If information about a staircase can be retrieved from a database, the staircase can also be recognized by comparing the position of the staircase with the current position of the vehicle, for example by comparing the GPS signal. To avoid having to push the vehicle up the stairs, this information can also be used to define a route early on that bypasses one or more stairs.

According to a favorable further development of the invention, the sensor signal is designed as information for an external device and/or the cloud and/or a server and/or is processed internally by the sensor unit. The advantage of this is the flexible processing of sensor signals.

Further important features and advantages of the invention can be seen from the sub-claims, from the drawings and from the associated description of the figures.

It goes without saying that the aforementioned features and the features yet to be explained in the following can be used not only in the respectively specified combination, but also in other combinations or on their own, without leaving the scope of the present invention.

Preferred designs and embodiments of the present invention are shown in the drawings and are explained in more detail in the following description.

This shows

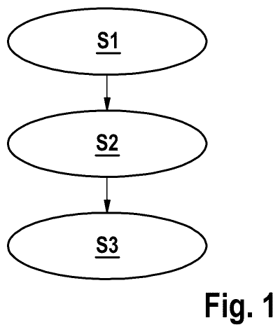

FIG. 1 in schematic form. Steps of a method according to one embodiment of the present invention.

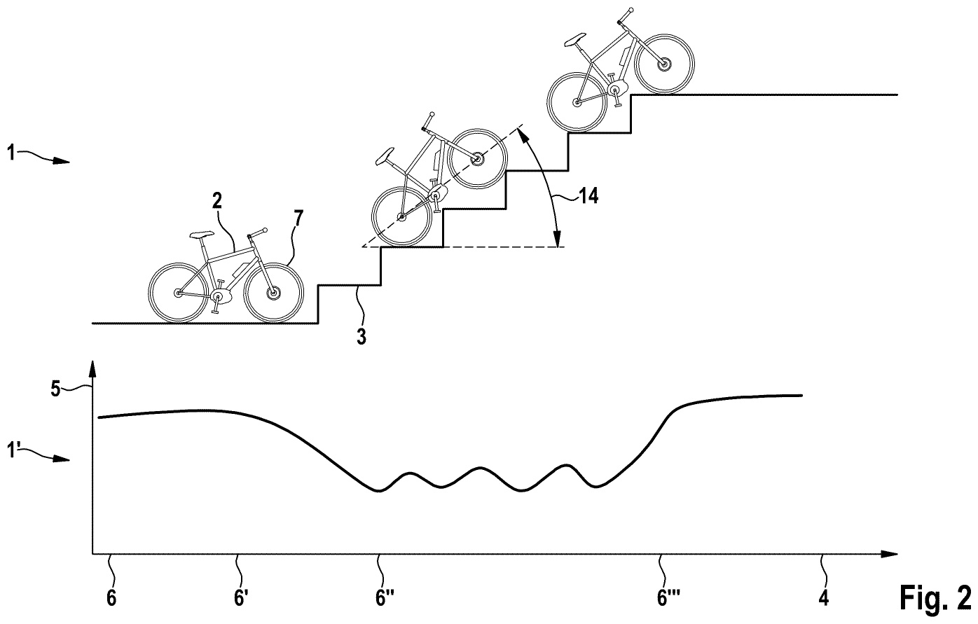

FIG. 2 schematically shows a curve of a rotational speed of a drive unit according to one embodiment of the present invention; and

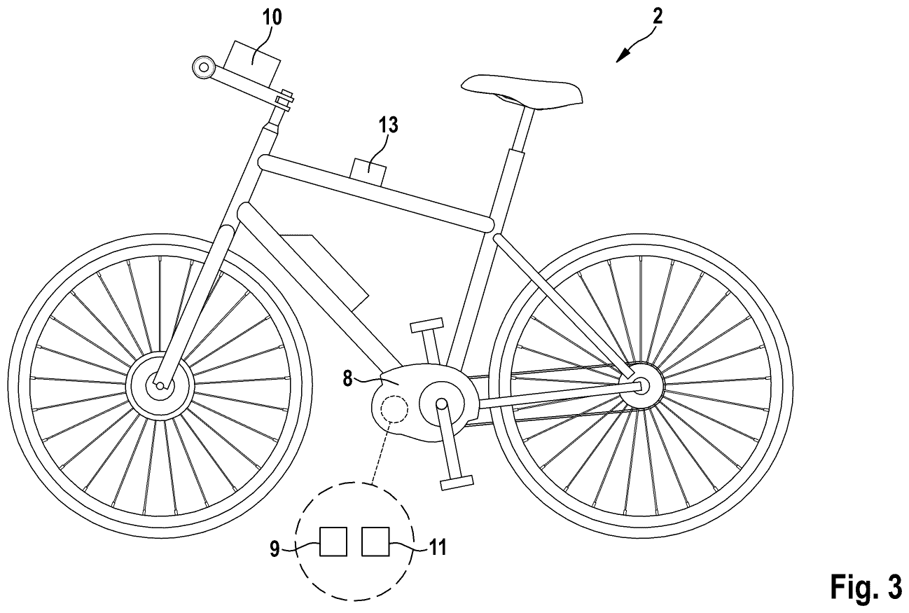

FIG. 3 in schematic form, a vehicle according to an embodiment of the present invention;

FIG. 1 schematically shows steps of a method according to an embodiment of the present invention.

The method for controlling a drive unit 8, in particular of a single-track vehicle 2 such as an eBike, comprising a sensor unit 10 with at least one sensor element, comprises the following steps.

In a first step S1, a sensor signal is detected by the at least one sensor element of the sensor unit 10.

In a second step S2, the staircase is determined based on the detected sensor signals, in particular from the sensor unit 10. The detection of the stairs can be recognized before reaching the stairs, for example, by an optical recognition system and/or during the pushing of the vehicle, for example, by a cyclic acceleration of the vehicle.

In a third step S3, the drive unit 8 is controlled based on the determined staircase. For example, the control may include adjusting a pushing assistance 9 or adjusting a level of assistance based on the determined staircase and/or detecting an alternate path to bypass the staircase.

FIG. 2 schematically shows a rotational speed curve of a drive unit 8 according to one embodiment of the present invention.

The upper part of the drawing shows the curve 1 of the position of a vehicle 2, here in the form of an eBike, on a staircase 3. The lower section shows the curve of rotational speed 1′ of a drive unit 8 (shown in FIG. 3) of the vehicle 2. The X-axis 4 shows the qualitative position on the staircase 3 and the Y-axis 5 shows the rotational speed of the drive unit 8, each in any unit.

First, vehicle 2 is moved at high speed towards the staircase 3. The drive unit 8 thus has a high rotational speed in the first position 6. According to step S1 of FIG. 1, the vehicle 2 is approached to the staircase 3.

In the second position, 6′, vehicle 2 hits the staircase 3. As a result, the front wheel 7 of the vehicle 2 is raised when the vehicle continues to move, causing the pitch angle 14 of the vehicle 2 to increase. This increase is measured, for example, by a gyroscope (not shown) of the vehicle 2 and automatically determined from this that the vehicle is moved over a staircase 3 according to step S2 of FIG. 1. It is also possible for the vehicle 2 to have an inertial sensor that can detect the cyclical acceleration curves caused by the steps when driving through the staircase 3 and thus recognize the staircase 3. Furthermore, it is possible that a camera (not shown) is mounted on the vehicle 2, with which the staircase 3 can be optically recognized. Furthermore, the power required to push vehicle 2 up from one step to the next—i.e. when climbing a step—is higher than when pushing vehicle 2 along the step to the next step. As a result, the drive unit 8 has a cyclic rotational speed, or a cyclic current strength in the drive unit 8. From this, the presence of staircase 3 can also be determined.

As soon as the staircase 3 is recognized, the control of the drive unit is executed as a subsequent action based on the determined staircase 3, for example, a pushing assistance 9 of the vehicle 2 is activated or adjusted according to step S3 of FIG. 1. First, the speed of vehicle 2 is reduced to allow a user to better control the vehicle. At position 6″, the drive unit 8 of vehicle 2 is running at a low rotational speed, which means that the speed of vehicle 2 is also low.

From position 6″, the rotational speed of the drive unit 8 is periodically increased and decreased again. This allows a user to push the vehicle 2 up the staircase 3 in a more comfortable way. Before the front wheel 7 hits a step of the staircase 3, the speed of the vehicle 2 is reduced to minimize the impact on the vehicle 2. After that, the speed is increased slightly so that the vehicle 2 can be pushed up the staircase 3 faster and easier until the front wheel 7 hits the next step. The increase and/or reduction of speed can be dependent on the height of the steps, so that, for example, the speed can be lower for high steps than for low steps.

To prevent one of the wheels of vehicle 2 from slipping when pushing up, in particular when a rear wheel of vehicle 2 reaches a step, the pushing assistance 9, in particular the torque of the pushing assistance 9, can be slowly increased. This means that the pushing assistance 9 is increased more slowly when a rear wheel encounters a step than when a front wheel 7 encounters a step. This prevents vehicle 2 from losing its grip on the staircase.

The geometry of the staircase 3 can be determined from the measured accelerations and/or the rotation rates of the vehicle 2. This information can be stored so that it can be used directly to adjust the pushing assistance 9 when the staircase 3 is moved through again.

At position 6″′, the front wheel 7 has now reached the end of the staircase 3, so that the rotational speed of the drive unit 8 and thus the speed of the vehicle 2 can be increased again.

Another possible example of how to control the drive unit is to determine an alternative route to bypass the staircase 3. This means that the user would not have to push the vehicle 2 up the staircase 3.

FIG. 3 schematically shows a vehicle according to an embodiment of the present invention.

A vehicle 2, here in the form of an eBike, includes a drive unit 8 and a pushing assistance 9. The pushing assistance 9 can be part of the drive unit 8. Furthermore, the vehicle 2 includes a sensor unit 10 designed to automatically detect the staircase 3 by means of the vehicle 2. The sensor unit 10 may include a gyroscope, an inertial sensor and/or a camera. In particular, the sensor unit 10 can be a smartphone. The sensor unit 10 can be used to recognize the geometry of the staircase 3.

In addition, the vehicle 2 has an execution device 11 for controlling the drive unit of the vehicle, based on the determined staircase 3. The control system of the vehicle can, for example, adjust the pushing assistance 9 based on the determined staircase 3. The drive unit 8 can include the execution device 11. The execution device 11 and the sensor unit 10 can be parts of a control unit of the drive unit 8 (not shown). The pushing assistance 9, for example, can be changed or adapted using the actuating mechanism 11 so that the vehicle 2 can be pushed up the determined staircase 3 in a manner suitable for a user.

Furthermore, the vehicle 2 can have a detection device 13. The investigation device 13 can be used to determine an alternative route so that a previous route can be avoided. For this purpose, the detection device 13 can have a card and/or a position detection system. The investigation facility 13 may be part of the execution facility 11.

In summary, at least one embodiment of the present invention has at least one of the following features and/or provides at least one of the following advantages:
increasing the user-friendliness of the pushing assistance.
more comfortable pushing up or driving up the stairs with the vehicle.
pushing or driving the vehicle with less effort.
controlling the vehicle based on a determined staircase.

Even though the present invention has been described with reference to preferred exemplary embodiments, it is not limited to these and can be modified in a variety of ways.

1. A method for controlling a drive unit of a vehicle, with the vehicle including the drive unit and a sensor unit with at least one sensor element, the method comprising:
sensing a sensor signal by the at least one sensor element of the sensor unit;
determining a staircase based on the detected sensor signal by the sensor unit; and
controlling the drive unit based on the determined staircase.

2. The method according to claim 1, wherein the staircase is determined on the basis of undulating and/or cyclical acceleration curves in the direction of a longitudinal vehicle axis of the vehicle.

3. The method according to claim 1, wherein the staircase is determined on the basis of an acceleration profile in the direction of a vertical vehicle axis.

4. The method according to claim 1, wherein the staircase is determined on the basis of an undulating and/or cyclical rotational speed curve in the direction of a pitching axis of the vehicle.

5. The method according to claim 1, wherein the staircase is detected on the basis of an undulating and/or cyclical rotational speed curve and/or a curve of one or more electrical drive characteristics in the drive unit of the vehicle.

6. The method according to claim 1, wherein the staircase is detected by way of an optical and/or acoustic detection device.

7. The method according to claim 1, wherein the staircase is detected on the basis of position data of the vehicle and/or position data of the staircase.

8. The method according to claim 1, wherein the control of the drive unit includes an adjustment of an assistance level of the drive unit.

9. The method according to claim 1, wherein the drive unit has a pushing assistance and wherein the control of the drive unit comprises an automatic activation and/or adaptation of the pushing assistance.

10. The method according to claim 1, wherein the control of the drive unit comprises an adjustment or modification of the pushing assistance of the drive unit of the vehicle.

11. The method according to claim 1, wherein the control of the drive unit is additionally carried out taking into account a length, height, incline, start, end, step height, and/or regularity of a step height of the staircase.

12. The method according to claim 1, wherein the control of the drive unit is additionally based on taking into account a position and/or rotation of the vehicle with respect to the staircase, at least one of an acceleration of the vehicle, a step height, and a regularity of the step height.

13. The method according to claim 1, wherein the control of the drive unit additionally comprises determining an alternative route to bypass the staircase.

14. The method according to claim 1, wherein the control of the drive unit is additionally based on a predicted impact event on a step.

15. The method according to claim 1, wherein the control of the drive unit is additionally based on a setting of the user.

16. The method according to claim 1, wherein the control of the drive unit additionally comprises storing information about the determined staircase in a local and/or global database.

17. The method according to claim 1, wherein the sensor signal is in the form of information of an external device and/or the cloud and/or a server and/or is processed internally by the sensor unit.

18. A method for determining route information, wherein at least one route segment has information that was determined by a method according to claim 16.

19. A drive unit for a single-track vehicle comprising a sensor unit with at least one sensor element, wherein the drive unit is designed to carry out the method according to claim 1.

20. An eBike, comprising a drive unit according to claim 19.

21. (canceled)
